(19) United States
(12) Patent Application Publication
(10) Pub. No.: US 2008/0278441 A1
(43) Pub. Date: Nov. 13, 2008

(54) USER CONTROL IN A PLAYBACK MODE

(75) Inventor: Christopher W. LARSEN, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/830,189

(22) Filed: Jul. 30, 2007

Related U.S. Application Data
(60) Provisional application No. 60/916,520, filed on May 7, 2007.

(51) Int. Cl. G09G 5/00

(52) U.S. Cl. 345/156

(57) ABSTRACT

A system comprises a display and logic coupled to the display. The logic causes a user control to automatically be displayed on the display upon a user activating an input device in both a full screen playback mode and a preview playback mode.

### BACKGROUND

Media content can be played on a computer. User controls such as volume, pause, play, etc. are displayed to the user on the computer display to enable a user to control the playback experience. Different playback modes (e.g., preview mode, full screen mode, etc.) may comprise different graphical representations for on-screen user controls and/or different techniques by which a user accesses the controls which, unfortunately, complicate the playback experience for a user.

### BRIEF DESCRIPTION OF THE DRAWINGS

For a detailed description of exemplary embodiments of the invention, reference will now be made to the accompanying drawings in which:

FIG. 1 shows a system in accordance with various embodiments;

FIG. 2 shows an illustrative preview mode in accordance with various embodiments;

FIG. 3 shows an illustrative full screen playback mode in accordance with various embodiments; and

FIG. 4 shows a method in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

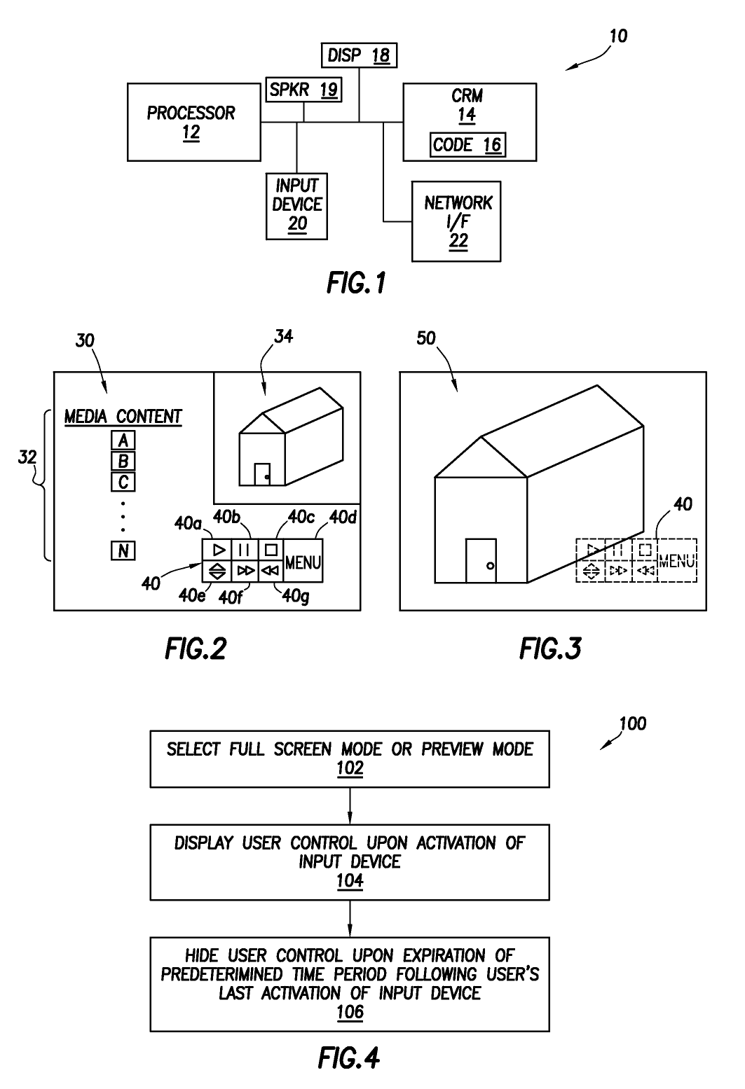

FIG. 1 shows a system 10 in accordance with various embodiments. As shown, system 10 comprises a processor 12 coupled to a computer-readable medium 14, a display 18, speaker 19, and an input device 20. Processor 12 executes code 16 stored on the computer-readable medium 14. In at least embodiment, the processor 12 executing code 16 causes system 10 to perform one or more of the functions described herein attributable to system 10. Computer-readable medium 14 comprises volatile storage (e.g., random access memory), non-volatile storage (e.g., hard disk drive, Flash memory, read-only memory, compact disc read-only memory, etc.), and combinations thereof. A user of system 10 interacts with input device 20 and display 18 to operate system 10. The network interface 22 enables the system to communicate with other devices across a network. In various embodiments, system 10 comprises a computer. The input device 20 comprises a keyboard, a mouse, track ball, or other type of pointing device. In at least some embodiments the computer 10 comprises a desktop computer, notebook computer, or other type of computing device.

At least one of the functions performed by system 10 is to enable a user to select one or more of multiple media content selection to play on display 18 and speaker 19. Such media content may comprise audio, video, and combinations thereof. In some embodiments the media content comprises a video stored on a digital video disk (DVD). In other embodiments the media content is downloaded to system 10 from a remote site across a network through network interface 22.

The system 10 enables media content to be played in one of at least two playback modes. FIGS. 2 and 3 illustrate two such playback modes. FIG. 2 illustrates a preview playback mode and FIG. 3 illustrates a full screen playback mode.

Referring to FIG. 2, the preview playback mode comprises a graphical user interface 30 that is shown on display 18. The user interface 30 comprises various elements as shown in FIG. 2. One such element comprises a list of media content items 32, each of which is selectable by a user using input device 20 for playback on system 10. Each of the selectable media content items (e.g., A, B, C, etc.) comprises a graphical representation of media content that can be played by the user. The preview playback mode also comprises a preview pane 34 which spans some, but not all, of the viewable display area of display 18. While in the preview playback mode, a user can select a media content to be played in the preview pane 34. Preview playback mode may also be referred to as a media content selection mode.

The preview playback mode also comprises one or more user controls 40. Such user controls 40 enable a user to control the playback of the selected media content. In at least one embodiment, the user controls 40 comprise various controls such as PLAY 40A, PAUSE 40B, STOP 40C, MENU 40D, VOLUME 40E, FAST FORWARD 40F, and REVERSE 40G. While viewing the selected media content in preview pane 34, the user controls 40 are hidden from the user. That is, the user controls 40 are not shown on display 18. Upon the user “activating” input device 20, however, the system 10 causes the user controls 40 to be shown on display 18. Activating the input device 20 comprises, for example, moving a mouse or track ball at least enough for the system 10 to detect the movement, pressing a key on a keyboard, or any other such interaction with an input device 20. Once the input device 20 is activated in some way, the system 10 automatically displays the user controls 40 in the preview mode's user interface 30. The user can then interact with the user controls 40 (e.g., use a mouse to click on a control 4a-40g) to control the playback experience in the preview pane 34 as desired. For example, the user may activate the PAUSE control 40B or FAST FORWARD control 40F.

Once a predetermined period of time has expired following the last time the user interacted with the user controls 40, the system 10 automatically causes the user controls 40 to disappear. In other embodiments, the predetermined period of time is measured from the latter of user interaction with user controls 40 and activation of input device 20. In at least some embodiments the predetermined period of time is user-programmable. An example of a suitable period of time is 10 seconds. The user controls 40 can be made to reappear by again activating the input device 20.

FIG. 3 shows an example of a graphical user interface 50 for a full screen playback mode. In the full screen playback mode, the media content has been selected and is playing on display 18 while spanning the entire viewable area of the display 18. Although the media content spans the entire viewable display area of the display 18, the user controls 40 can be used in much the same way as in the preview playback mode. That is, upon the user activating (e.g., moving enough to be detected by system 10) the input device 20, the system 10 automatically causes the user controls 40 to be displayed on display 18. In some embodiments, the user controls 40 are shown superimposed on top of the media content being displayed in the full screen playback mode. As in the preview playback mode, once a predetermined period of time has expired following the last time the user interfaced with user controls 40 or the last time the user interacted with the user controls 40 or activated input device 20, the system 10 causes the user controls 40 to disappear from the display 18. Accordingly, in at least some embodiments, the manner in which the user can cause the user controls 40 to appear and disappear is substantially the same in both the preview playback mode and the full screen playback mode.

FIG. 4 illustrates a method 100 in accordance with various embodiments. At 102, method 100 comprises a user selecting a full screen mode or the preview mode. For example, while in the preview playback mode, a selectable button can be provided that causes the full screen mode to be initiated. In other embodiments, a button on a keyboard can cause the system 10 to switch between the preview and full screen playback modes. At 104, the method comprises displaying the user controls 40 upon activation of the input device as described above. At 106, the method comprises hiding the user control upon expiration of the predetermined time period following the user's last activation of the input device.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a display; and
logic coupled to said display, said logic causes a user control to automatically be displayed on said display upon a user activating an input device in both a full screen playback mode and a preview playback mode.

2. The system of claim 1 wherein, while in said preview playback mode, said logic enables a user to select media content for playback on said display.

3. The system of claim 1 wherein said logic causes said user control to disappear after a predetermined amount of time has elapsed since the user last interacted with the user control.

4. The system of claim 1 wherein, for both said full screen playback mode and said preview playback mode, said logic causes said user control to disappear after a predetermined amount of time elapses since the latter of the time the user last interacted with the user control or last activated the input device.

5. The system of claim 1 wherein said user control comprises a control for controlling the playback of media content.

6. The system of claim 1 wherein said user control comprises at least one control selected from a group consisting of volume, play, pause, fast forward, reverse, and menu.

7. The system of claim 1 wherein said logic causes media content to be played on said display in either of said full screen and preview playback modes as selected by a user.

8. The system of claim 1 wherein said input device comprises a keyboard or pointing device.

9. A method, comprising:
selecting from a full screen playback mode and a preview playback mode a mode to play media content; and
displaying a user control in said selected mode upon a user upon a user activating an input device.

10. The method of claim 9 further comprising hiding said user control upon expiration of a predetermined time following a user's last interaction with the user control.

11. The method of claim 9 further comprising, regardless of the selected mode, hiding said user control upon expiration of a predetermined time following a user's last interaction with the user control.

12. The method of claim 9 wherein displaying the user control comprises displaying a user control usable to control playback of said media content.

13. The method of claim 9 further comprising playing said media content in the selected mode.

14. The method of claim 9 wherein, while in said preview playback mode, providing a user interface that enables a user to select media content.

15. A computer-readable medium (CRM) comprising software that when executed by a processor causes the processor to:
select from a full screen playback mode and a preview playback mode a mode to play media content; and
display a user control in said selected mode upon a user upon a user activating an input device.

16. The CRM of claim 15 wherein the software further causes the processor to hide said user control upon expiration of a predetermined time following a user's last interaction with the user control.

17. The CRM of claim 15 wherein, regardless of the selected mode, the software further causes the processor to hide said user control upon expiration of a predetermined time following a user's last interaction with the user control.

18. The CRM of claim 15 wherein the software causing the processor to display the user control comprises the software causing the processor to display a user control usable to control playback of said media content.

19. The CRM of claim 15 wherein the software further causes the processor to play said media content in the selected mode.

20. The CRM of claim 15 wherein, while in said preview playback mode, wherein the software further causes the processor to provide a user interface that enables a user to select media content.
